(19) United States
(12) Patent Application Publication
(10) Pub. No.: US 2022/0212516 A1
(43) Pub. Date: Jul. 7, 2022

(54) CAB ISOLATION SYSTEM

(71) Applicant: Dana Heavy Vehicle Systems Group, LLC, Maumee, OH (US)

(72) Inventor: Jeremy M. FRENZNICK, Brighton, MI (US)

(21) Appl. No.: 17/646,984

(22) Filed: Jan. 4, 2022

Related U.S. Application Data
(60) Provisional application No. 63/134,073, filed on Jan. 5, 2021.

(51) Int. Cl. B60G 99/00; B62D 33/06; B60H 1/00

(52) U.S. Cl. CPC B60G 99/002; B60G 2300/02; B60H 1/00378; B62D 33/0604

(57) ABSTRACT

Methods and systems are provided for a medium duty vehicle. In one example, the medium duty vehicle has a storage compartment with a first suspension system and a cab with a separate, second suspensions system. The cab may be separated from the storage compartment by a physical barrier and may include a rearward extension overlapping with the storage compartment.

### CROSS REFERENCE TO RELATED APPLICATION

The present application claims priority to U.S. Provisional Application No. 63/134,073, entitled “CAB ISOLATION SYSTEM”, and filed on Jan. 5, 2021. The entire contents of the above-listed application are hereby incorporated by reference for all purposes.

### TECHNICAL FIELD

The present description relates generally to methods and systems for a cab isolation system for medium duty trucks, fixed frame cargo trucks, and city delivery vehicles.

### BACKGROUND AND SUMMARY

A medium duty vehicle, such as city delivery vehicles and fixed frame cargo trucks, may be configured to maximize cargo space to provide efficient transport of goods. As current trends in consumer spending have migrated towards online purchases, reliance on delivery of products in urban areas has risen substantially. As such, a driver may spend prolonged periods of time in the vehicle and endure a variety of environmental conditions, such as large variations in ambient temperature and road surface quality. Furthermore, a lack of insulating separation between a cab and a cargo area of the vehicle may demand heating and cooling of the cargo area in addition to the cab to achieve a comfortable climate within the vehicle. Energy efficiency of the vehicle may be reduced as a result. In addition, the vehicle may have a stiff suspension in order to support heavy loads. The stiff suspension may subject the driver to harsh road conditions, leading to further discomfort.

In one example, the issues described above may be addressed by a medium duty vehicle, comprising a storage compartment with a first suspension system, a cab arranged forward of the storage compartment and separated from the storage compartment by a physical barrier, the cab having a rearward extension overlapping with the storage compartment, wherein the cab has a second suspension system separate from the first suspension system. In this way, a driver may experience more comfortable driving conditions and an energy efficiency of the vehicle may be increased.

As one example, the second suspension system may be softer than the first suspension system, absorbing more vibrations and reducing noise, harshness and vibrations (NVH) experienced by the driver. The rearward extension of the cab allows the cab to merge with the storage compartment in an aesthetically appealing manner while the physical barrier enables environmental isolation of the cab from the storage compartment. As a result, the cab may be heated or cooled with reduced energy waste.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a side view of a first example of a medium duty vehicle with a recessed cab and a secondary suspension for the cab.

FIG. 2 shows a top view of the medium duty vehicle of FIG. 1.

FIG. 3 shows an isometric view of the medium duty vehicle of FIG. 1.

FIG. 4 shows an example of a cab which may be implemented in the medium duty vehicle of FIGS. 1-3.

FIG. 5 shows an isometric view of a second example of a medium duty vehicle.

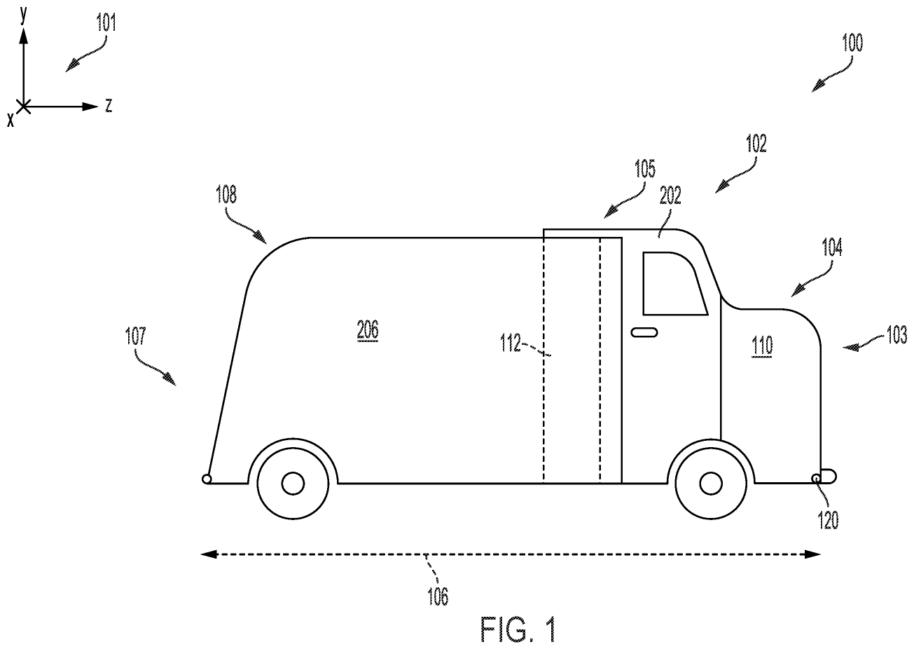

FIGS. 1-5 are shown approximately to scale

### DETAILED DESCRIPTION

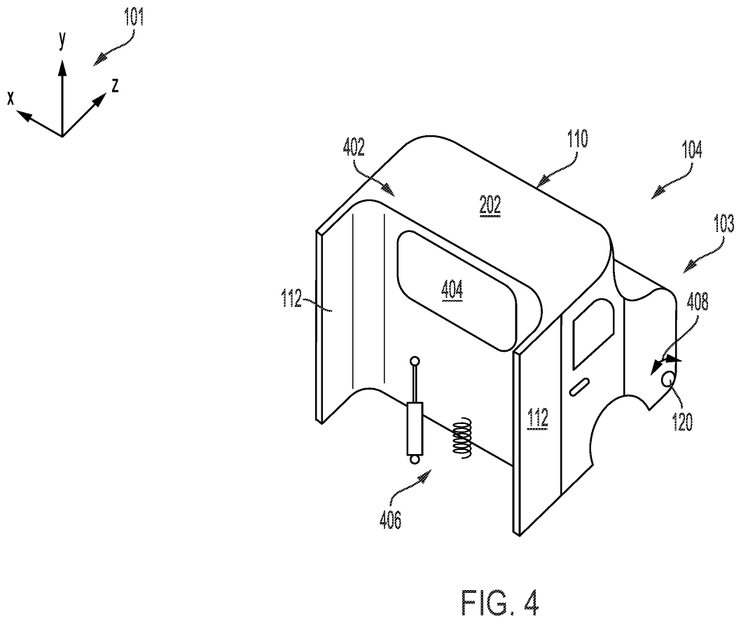

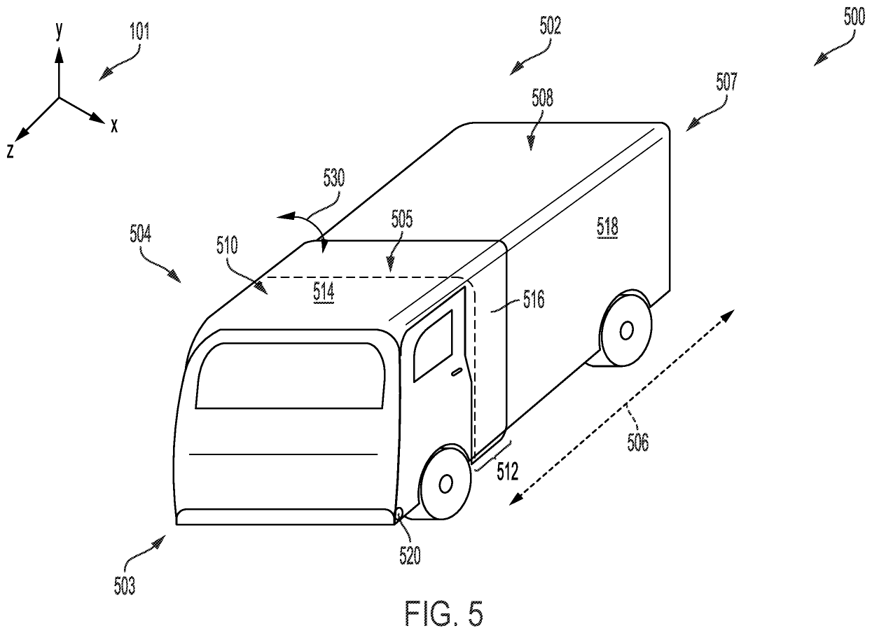

The following description relates to systems and methods for a medium duty vehicle. The vehicle may include a cab with an interior environment separated from a storage compartment. An exterior surface of the cab may at least partially envelope the storage compartment, as shown in a first example of a vehicle in FIGS. 1-3. The cab, as illustrated in FIG. 4, may include a barrier or wall dividing an interior of the cab from an interior of the storage compartment and the cab may be configured with a separate suspension system from the storage compartment of the vehicle. An overlapping region of the cab with the storage compartment may vary in geometry, as shown in FIG. 5. By adapting the vehicle with a cab that is isolated from the storage compartment, a driver may experience a more comfortable ride, particularly over prolonged periods of driving and energy may be conserved.

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Drivers of medium duty vehicles may spend prolonged periods of times in a vehicle cab. Conventional vehicles may include a common suspension system applied to both the cab and a storage compartment where the common suspension system may be stiff to accommodate heavy loads. Furthermore, a lack of insulation between the cab and the storage compartment may result in energy waste when the cab is heated or cooled to a desired comfort level of the driver. In order to at least partially address these issues while maintaining an accessibility of the cab and an aesthetic appeal of the vehicle, the vehicle may have an isolated cab with an independent suspension system. The cab may merge with the storage compartment in a smooth and seam-free configuration such that exterior surfaces of the vehicle are uninterrupted. An example of the vehicle is shown in FIGS. 1-3 from a side view 100, a top view 200, and an isometric view 300, respectively.

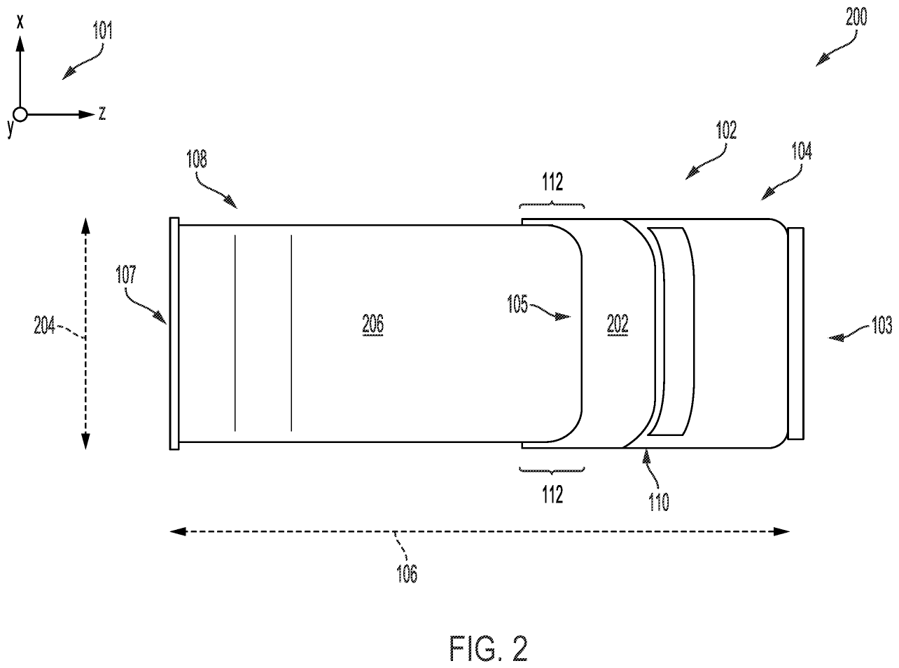

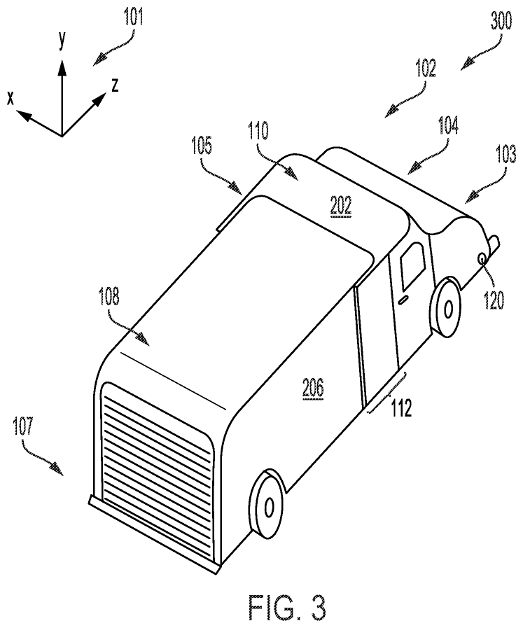

Turning now to FIG. 1, a vehicle 102 is depicted having a cab 104 extending from a front end 103 of the vehicle 102 to a mid-region 105 along a length 106 of the vehicle and a storage compartment 108 extending from a rear end 107 of the vehicle 102 to the mid-region 105. A set of references axes 101, indicating a y-axis, an x-axis, and a z-axis, are provided for comparison between views shown. In one example, the y-axis may be parallel with a direction of gravity. The cab 104 may have an outer surface 110 which includes flaps 112 along each vertical (with respect to the y-axis) side of the vehicle 102, as shown in FIG. 2. The flaps 112 may overlap with a portion of the storage compartment 108 along the length 106 of the vehicle 102. As such, the flaps may extend further along the length 106 of the vehicle 102 than a roof 202 of the outer surface 110 of the cab 104, and further along the length 106 than the cab 104, as shown in FIGS. 2 and 3.

In one example, as shown in FIG. 2, a width 204 of the vehicle 102 may be greater across the flaps 112 of the cab than across the storage compartment 108. As such, the flaps 112 overlap with an outer surface 206 of the storage compartment 108, e.g., inner surfaces of the flaps 112 are in face-sharing contact with the outer surface 206 of the storage compartment 108. In some examples, the width 204 of the vehicle 102, e.g., along the storage compartment 108, may be reduced at least along a portion of the length 106 of the vehicle 102 where the flaps 112 overlap with the storage compartment 108 (the reduced width not shown in FIGS. 1-3). In this way, the flaps 112 may be arranged in recesses in the outer surface 206 of the storage compartment 108, allowing the outer surface 110 of the cab 104 to merge with the outer surface 206 of the storage compartment 108 smoothly and without interruption.

The cab 104 is depicted separated from the storage compartment of the vehicle in FIG. 4. The flaps 112 protrude away from the front end 103 along the z-axis. Each of the flaps 112 may have a rectangular geometry. In other examples, the flaps may have a variety of quadrilateral shapes, a triangular geometry, etc. The cab 104 includes a rear wall 402 which provides a barrier between the cab 104 and the storage compartment, e.g., the storage compartment 108 of FIGS. 1-3, of the vehicle. The rear wall 402 may have a window 404 to allow a driver to view an interior of the storage compartment from the cab 104. In some examples, the rear wall 402 may alternatively or additionally include a door, allowing the driver to move between the cab 104 and the storage compartment 108 through the door. The rear wall 402 may include insulation to allow the cab 104 and the storage compartment to have different inner environments without affecting one another. For example, the cab 104 may be heated or cooled independently of heating/cooling of the storage compartment 108.

The cab 104 may be configured with a separate and independent suspension system 406 from a suspension system of the storage compartment. As a result, a coupling of the cab 104 to a chassis of the vehicle may be independent of a coupling of the storage compartment to the chassis, enabling the suspension of the cab to have a different stiffness from a stiffness of the suspension of the storage compartment. As an example, a lower demand of the cab for supporting weight (e.g., heavy loads) may allow the suspension system of the cab to be softer than the suspension system of the storage compartment. The softer suspension system of the cab may provide greater dampening of movement and reduce NVH experienced by the driver.

It will be appreciated that the vehicle 102 and cab 104 depicted in FIGS. 1-4 are non-limiting examples of a geometry the vehicle and components of the vehicle. For example, variations in a shape of the cab 104 are possible, as shown in FIG. 5. Therein, a second example of a vehicle 502 is depicted from an isometric view 500. The vehicle 502 may also be a medium duty vehicle with a cab 504 arranged at a front end 503 of the vehicle 502. The cab 504 may couple to a storage compartment 508 along a mid-region 505 (indicated by a dashed line) of a length 506 of the vehicle 502, the storage compartment 508 extending between the mid-region 505 and a rear end 507 of the vehicle 502.

An outer surface 510 of the cab 504 may include an extension 512 protruding away from the cab 504 towards the rear end 507 of the vehicle 502, similar to the flaps 112 shown in FIGS. 1-4. The extension 512, however, may extend equally along the length 506 of the vehicle 502 at a roof 514 of the outer surface 510 and at sides 516 of the outer surface 510. The extension 512 may overlap with the an outer surface 518 of the storage compartment 508 and may be configured to slide into a recess in the outer surface 518 of the storage compartment 508 such that the outer surfaces of the cab 504 and the storage compartment 508 are flush with one. The outer surface 510 of the cab 504 and the outer surface 518 of the storage compartment 508 may thereby merge smoothly and without interruption. However, in other examples, the extension 512 may not mate with the recess in the outer surface 518 of the storage compartment 508 and may instead protrude outwards from the vehicle 502 more than the storage compartment 508 (e.g., along the y- and x-axes).

An amount of overlap of the cab with the storage compartment, e.g., at the flaps 112 of FIGS. 1-4 or the extension 512 of FIG. 5, may vary. In one example, the flaps or extension may form 20% of the length of the vehicle. In other examples, the flaps or extension may form anywhere between 10%-30% of the length of the vehicle.

Furthermore, the cab may be pivotable to enable access to the vehicle engine. For example, as shown in FIGS. 1 and 3-4, the cab 104 may have a pivot point 120 at a bottom, front region of the cab 104. The cab 504 of FIG. 5 may have a similar pivot point 520. The cab may pivot around the pivot point, as indicated by arrow 408 in FIG. 4, through the y-z plane. An end of the cab proximate to the rear end of the vehicle may be lifted from the vehicle chassis to expose the engine by pivoting the cab through the y-z plane, as indicated by arrow 530 in FIG. 5. Thus, access to the engine is readily available when maintenance is demanded.

In some examples, the cab may have a separate heating, ventilation, and air conditioning (HVAC) system from the storage compartment. For example, temperature-sensitive cargo requiring cold temperature storage may demand maintaining the storage compartment at temperatures lower than ambient temperature. The low temperature in the storage compartment may be an uncomfortable temperature for the driver, however. By implementing separate HVAC systems, the driver may adjust the temperature of the cab to a comfortable temperature without affecting the temperature in the storage compartment. Inefficient heating and cooling of the cab is thereby mitigated. In other examples, the storage compartment may not have an HVAC system.

In this way, a cab of a medium duty vehicle may be isolated from a storage compartment. The cab may have a physical barrier, such as a rear wall, allowing the cab to have an independent inner environment from the storage compartment, and have a separate suspension system from the storage compartment. The cab may overlap with the storage compartment such that an outer surface of the cab merges with an outer surface of the storage compartment in a smooth, flush, and uninterrupted manner. The cab may be pivotable to allow easy access to an engine of the vehicle. As a result, driver comfort is increased.

The disclosure also provides support for a medium duty vehicle, comprising: a storage compartment with a first suspension system, a cab arranged forward of the storage compartment and separated from the storage compartment by a physical barrier, the cab having a rearward extension overlapping with the storage compartment, wherein the cab has a second suspension system separate from the first suspension system. In a first example of the system, the first suspension system is stiffer than the second suspension system. In a second example of the system, optionally including the first example, the rearward extension extends further along a length of the medium duty vehicle, in a direction from a merging point of the cab with the storage compartment to a rear end of the medium duty vehicle, at sides of the medium duty vehicle than at a roof of the medium duty vehicle. In a third example of the system, optionally including one or both of the first and second examples, the rearward extension extends equally towards a rear end of the medium duty vehicle at sides and a roof of the medium duty vehicle. In a fourth example of the system, optionally including one or more or each of the first through third examples, an inner surface of the rearward extension is in face-sharing contact with an outer surface of the storage compartment. In a fifth example of the system, optionally including one or more or each of the first through fourth examples, an outer surface of the cab is flush with the outer surface of the storage compartment along sides and a roof of the medium duty vehicle at a merging point of the cab with the storage compartment. In a sixth example of the system, optionally including one or more or each of the first through fifth examples, the outer surface of the cab protrudes outwards, away from an interior of the cab, more than the outer surface of the storage compartment and wherein the outer surface of the cab is offset from the outer surface of the storage compartment at a merging point of the cab with the storage compartment. In a seventh example of the system, optionally including one or more or each of the first through sixth examples, the cab is configured to pivot at a hinge arranged at a lower region of a front end of the cab. In a eighth example of the system, optionally including one or more or each of the first through seventh examples, the physical barrier is configured to insulate an interior of the cab from an interior of the storage compartment. In a ninth example of the system, optionally including one or more or each of the first through eighth examples, the cab has an independent climate control system from the storage compartment.

The disclosure also provides support for a vehicle, comprising: a chassis, a storage compartment coupled to the chassis by a first suspension system, a cab coupled to the chassis by a second suspension system and coupled to the storage compartment by a portion of the cab configured to surround the storage compartment, and a pivotable hinge arranged at a forward region of the cab, the pivotable hinge configured to enable pivoting of the cab to access an engine of the vehicle. In a first example of the system, the cab is positioned forward of the storage compartment and wherein the storage compartment is recessed into the portion of the cab surrounding the storage compartment. In a second example of the system, optionally including the first example, the second suspension system is configured to absorb more vibrations than the first suspension system. In a third example of the system, optionally including one or both of the first and second examples, the pivotable hinge allows a rear end of the cab to be lifted when the cab is pivoted. In a fourth example of the system, optionally including one or more or each of the first through third examples, the cab has an insulating barrier separating an interior of the cab from an interior of the storage compartment. In a fifth example of the system, optionally including one or more or each of the first through fourth examples, the cab has a separate heating, ventilation, and air conditioning system from the storage compartment. In a sixth example of the system, optionally including one or more or each of the first through fifth examples, the vehicle is a medium duty vehicle.

The disclosure also provides support for a medium duty vehicle, comprising: a cab, coupled to a storage compartment by a region of the cab configured to overlap with the storage compartment, and having a suspension system separate from the storage compartment, wherein the cab is heated and cooled independent of the storage compartment. In a first example of the system, heating and cooling of the cab is insulated from the storage compartment by a rear wall of the cab. In a second example of the system, optionally including the first example, the region of the cab configured to overlap with the storage compartment extends from the rear wall along a portion of a length of the medium duty vehicle toward a rear end of the medium duty vehicle.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A medium duty vehicle, comprising:
a storage compartment with a first suspension system;
a cab arranged forward of the storage compartment and separated from the storage compartment by a physical barrier, the cab having a rearward extension overlapping with the storage compartment, wherein the cab has a second suspension system separate from the first suspension system.

2. The medium duty vehicle of claim 1, wherein the first suspension system is stiffer than the second suspension system.

3. The medium duty vehicle of claim 1, wherein the rearward extension extends further along a length of the medium duty vehicle, in a direction from a merging point of the cab with the storage compartment to a rear end of the medium duty vehicle, at sides of the medium duty vehicle than at a roof of the medium duty vehicle.

4. The medium duty vehicle of claim 1, wherein the rearward extension extends equally towards a rear end of the medium duty vehicle at sides and a roof of the medium duty vehicle.

5. The medium duty vehicle of claim 1, wherein an inner surface of the rearward extension is in face-sharing contact with an outer surface of the storage compartment.

6. The medium duty vehicle of claim 5, wherein an outer surface of the cab is flush with the outer surface of the storage compartment along sides and a roof of the medium duty vehicle at a merging point of the cab with the storage compartment.

7. The medium duty vehicle of claim 5, wherein the outer surface of the cab protrudes outwards, away from an interior of the cab, more than the outer surface of the storage compartment and wherein the outer surface of the cab is offset from the outer surface of the storage compartment at a merging point of the cab with the storage compartment.

8. The medium duty vehicle of claim 1, wherein the cab is configured to pivot at a hinge arranged at a lower region of a front end of the cab.

9. The medium duty vehicle of claim 1, wherein the physical barrier is configured to insulate an interior of the cab from an interior of the storage compartment.

10. The medium duty vehicle of claim 1, wherein the cab has an independent climate control system from the storage compartment.

11. A vehicle, comprising:
a chassis;
a storage compartment coupled to the chassis by a first suspension system;
a cab coupled to the chassis by a second suspension system and coupled to the storage compartment by a portion of the cab configured to surround the storage compartment; and
a pivotable hinge arranged at a forward region of the cab, the pivotable hinge configured to enable pivoting of the cab to access an engine of the vehicle.

12. The vehicle of claim 11, wherein the cab is positioned forward of the storage compartment and wherein the storage compartment is recessed into the portion of the cab surrounding the storage compartment.

13. The vehicle of claim 11, wherein the second suspension system is configured to absorb more vibrations than the first suspension system.

14. The vehicle of claim 11, wherein the pivotable hinge allows a rear end of the cab to be lifted when the cab is pivoted.

15. The vehicle of claim 11, wherein the cab has an insulating barrier separating an interior of the cab from an interior of the storage compartment.

16. The vehicle of claim 11, wherein the cab has a separate heating, ventilation, and air conditioning system from the storage compartment.

17. The vehicle of claim 11, wherein the vehicle is a medium duty vehicle.

18. A medium duty vehicle, comprising:
a cab, coupled to a storage compartment by a region of the cab configured to overlap with the storage compartment, and having a suspension system separate from the storage compartment, wherein the cab is heated and cooled independent of the storage compartment.

19. The medium duty vehicle of claim 18, wherein heating and cooling of the cab is insulated from the storage compartment by a rear wall of the cab.

20. The medium duty vehicle of claim 19, wherein the region of the cab configured to overlap with the storage compartment extends from the rear wall along a portion of a length of the medium duty vehicle toward a rear end of the medium duty vehicle.
